(19) United States
(12) Patent Application Publication
(10) Pub. No.: US 2024/0385307 A1
(43) Pub. Date: Nov. 21, 2024

(54) ON-CHIP PHASE NOISE MEASUREMENT SYSTEM FOR BUILD-IN SELF-TEST OF MULTIPLE HIGH-FREQUENCY OSCILLATOR SYSTEMS

(71) Applicant: Intel Corporation, Santa Clara, CA (US)

(72) Inventors: Lukas SCHRAMM, Munich (DE); Peter BAUMGARTNER, Munich (DE)

(21) Appl. No.: 18/318,754

(22) Filed: May 17, 2023

(51) Int. Cl. G01S 13/34; G01S 7/35

(52) U.S. Cl. CPC G01S 13/347; G01S 7/356

(57) ABSTRACT

A non-transitory computer readable medium having instructions stored therein that when executed by a processor cause the processor to: determine a time difference between a first reference point of a first signal and a second reference point of a second signal, the first signal modulated with a first frequency, and the second signal modulated with a second frequency different from the first frequency; to determine a phase noise based on the determined time difference; and to use the determined phase noise for processing a signal associated with the first signal.

### TECHNICAL FIELD

This disclosure generally relates to the field of signal source controlling and processing devices, e.g. generating a local oscillator for determining an information.

### BACKGROUND

Phase noise (PN) of oscillators matters in a wide variety of applications. For example, in a transmitter phase noise of a local oscillator (LO) can degrade the quality of the digital modulation and additionally can cause leakage of signal power into adjacent channels. This limitation becomes even more important with communication standards moving to mmWave frequencies and typical cellular transceivers containing eight or more high-frequency LOs for transmitting in different frequency bands. Further applications, where phase noise is a critical factor include receivers and RADAR, but also digital systems and optical systems, e.g. light detection and ranging (LIDAR) systems.

Thus, while specifications tighten, the down-scaling of silicon technologies leads to a higher variance in MOSFET (metal oxide semiconductor field effect transistor) Flicker noise, and therefore a higher variance in the low offset-frequency phase noise. It is therefore important to monitor the phase noise of the local oscillators on-chip to ensure that the local oscillator meets the specifications through the lifetime of a specific application (build-in self-test).

In both RADAR and LIDAR applications, the FMCW (frequency-modulated continuous wave) method is typically used. The frequency of the laser/electric wave is usually modeled with a saw-tooth function. However, random fundamental physical noise sources lead to non-idealities in the modulation of the laser/LO frequency (i.e. phase noise), which limit the accuracy of the measurement. In RADAR and LIDAR applications, there can be a variety of sources of phase noise, e.g. signal generation, frequency multiplier, mixer, clock for analog-to-digital converter (ADC).

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1 illustrates a system applying a signal correction method;

FIG. 2A to 2D show diagrams illustrating the signal correction method;

FIG. 3 illustrates a flow diagram for a signal correction method; and

FIG. 4 illustrates a device for applying the signal correction method.

### DESCRIPTION

The following detailed description refers to the accompanying drawings that show, by way of illustration, specific details and aspects in which the invention may be practiced.

The term “as an example” is used herein to mean “serving as an example, instance, or illustration”. Any aspect or design described herein as “as an example” is not necessarily to be construed as preferred or advantageous over other aspects or designs.

In a comparative example, off-chip measurements measure phase noise in a lab or production environment. However, off-chip measurements do not provide in-field monitoring over the product lifetime. Additionally, long test times results are required from off-chip measurements in the production environment.

In another comparative example, on-chip measurements use either a stable reference source or use a delayed version of the signal itself as a reference (also denoted as delay line method). However, in on-chip measurements it is not possible to supply a stable reference source on-chip. When using the delay line method, the phase noise cannot be measured with sufficient accuracy due to quantization errors of time-to-digital converters (TDCs), especially for high frequency oscillators in the mmWave range.

In comparison, using a plurality of different local oscillator signals, e.g. at least a first local oscillator signal having a first frequency and a second local oscillator signal having a second frequency, allows to determine the frequency stability of an oscillator on-chip by comparing its output signal to further LOs (of possibly different frequency). By measuring the jitter with a TDC, the PN of several LOs can be calculated with quantization having only negligible effects. This way, the measurement method provides high accuracy PN measurements of multiple LOs, e.g. for low phase noise and mmWave-frequency LOs. This may provide new applications, e.g. a power optimization by adjusting the power (and resulting oscillator amplitude) to a needed level, a compensation of process variation and adjustment to the needed performance, e.g. data rate, signal to noise ratio.

A ring wise comparison of LOs, e.g. of different frequencies, the phase noise at each of these LOs can be quantified and thus also faulty LO sources can be determined. In LIDAR and RADAR applications, a faster modulation bandwidth, e.g. a modulation towards higher maximum frequencies, leads to a more accurate distance measurement

$$δ D = c ( 1 + 2 πτ {vnl}_{rms} ) / ( 2 Δ v )$$

with distance measurement accuracy δD, speed of light c, phase noise vnlᵣₘₛ and modulation bandwidth Δv.

In summary, the described operation method of a signal source removes or reduces described limitations and allows the quantification of the phase noise of the signal source during the application also for systems with a fast modulation rate.

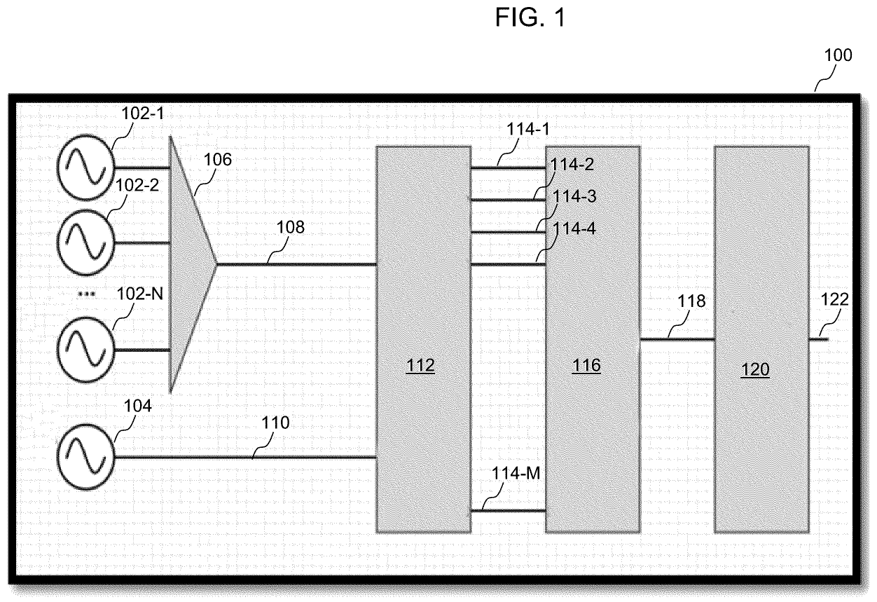

FIG. 1 illustrates a system applying a phase noise monitoring method. The system may be a device or apparatus or a part thereof. The system 100 may include at least a first local oscillator source (LO-source) 104 providing a first local oscillator signal (LO-signal) 110 (also denoted as first signal) and a second LO-source providing a second LO-signal 108 (also denoted as second signal). The second LO-source may include a plurality of LO-sources 102-1, 102-2, 102-3, 102-N coupled to a common multiplexer 106 to provide the second LO-signal 108. Although FIG. 1 illustrates a plurality of LO-sources 102-1, 102-2, 102-3, 102-N for the second LO-source there can be one or more LO-sources configured to provide one or more LO-signals that generate the second LO-signal 108 in parallel or subsequently respectively. In addition, system 100 may include the first LO-source and the second LO-source without any multiplexer.

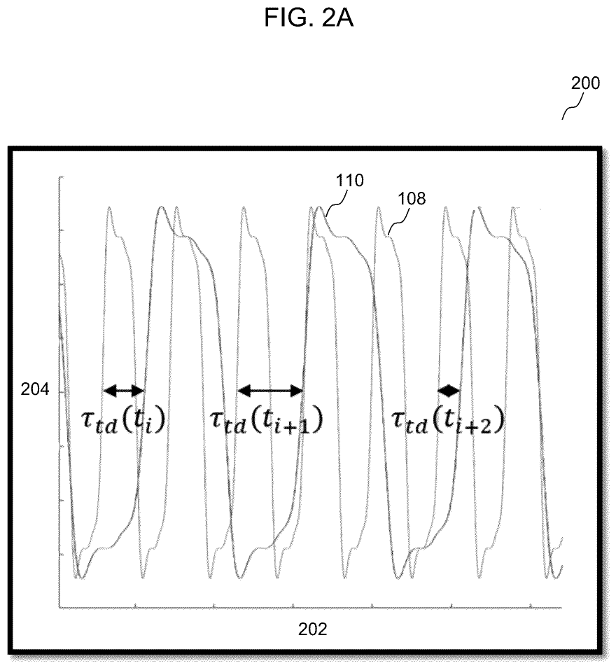

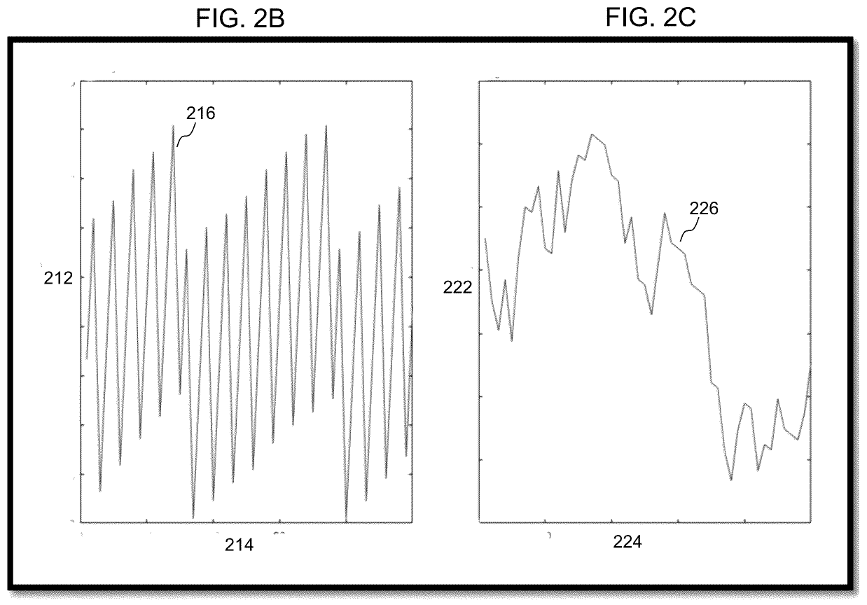

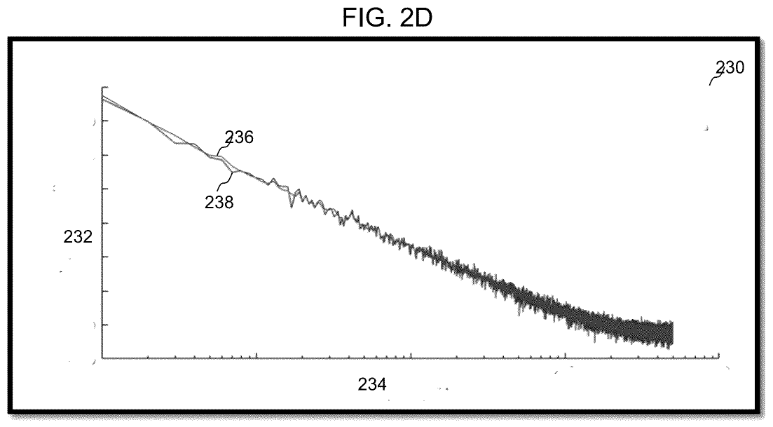

The LO-signals 108, 110 may have a signal modulation used as local oscillator depending on the respective application. The LO-signals 108, 110 may have one or more sin-wave signals, a pulse modulated signal, a pulse sequence, or any combination thereof. In addition, the LO-signals 108, 110 may have the same frequency or may have frequencies different to each other. As an example, the first LO-signal 108 and the second LO-signal 110 may have the same signal modulation but different frequencies, e.g., the frequency of the second LO-signal 108 may be a multiple of the frequency of the first LO-signal 110, as illustrated in FIG. 2A to FIG. 2D.

The first LO-signal 108 may be one of the LO-signals provided from one of the plurality of LO-sources 102-1, 102-2, 102-3, 102-N (also denoted as selected first LO-signal). The multiplexer 106 may be configured to provide the selected LO-signal(s), e.g. depending on the application, e.g. depending on a required frequency band. The first LO-signal 108 may be compared with the second LO-signal 110, e.g. to determine a phase noise. Illustratively, the second LO-signal 110 can be used as a LO-signal for the selected first LO-signal 108 to determine a phase noise of the first LO-signal or second LO-signal.

The selected first LO-signal 108 and the second LO-signal 110 may be provided to inputs of a first controller 112, the first controller 112 may be a time-to-digital-converter (TDC) 112 for example. The second LO-signal 110 may be used as a Clock-Signal for the first LO-Signal 108 in the TDC 112. The TDC 112 may provide digital signals 114-1, 114-2, 114-3, . . . , 114-M (also denoted as time signals) to a second controller 116 corresponding to a time 202 or timing (see FIG. 2A).

The second controller 116 may be configured for edge correction of the one or more time signals 114-1, 114-2, 114-3, . . . , 114-M. The second controller 116 generates a jitter function from one or more time differences of the LO-signals 108, 110 as described in more detail below. The second controller 116 generates an edge corrected signal 118 and may submit information of the corrected signal 118 to a third controller 120.

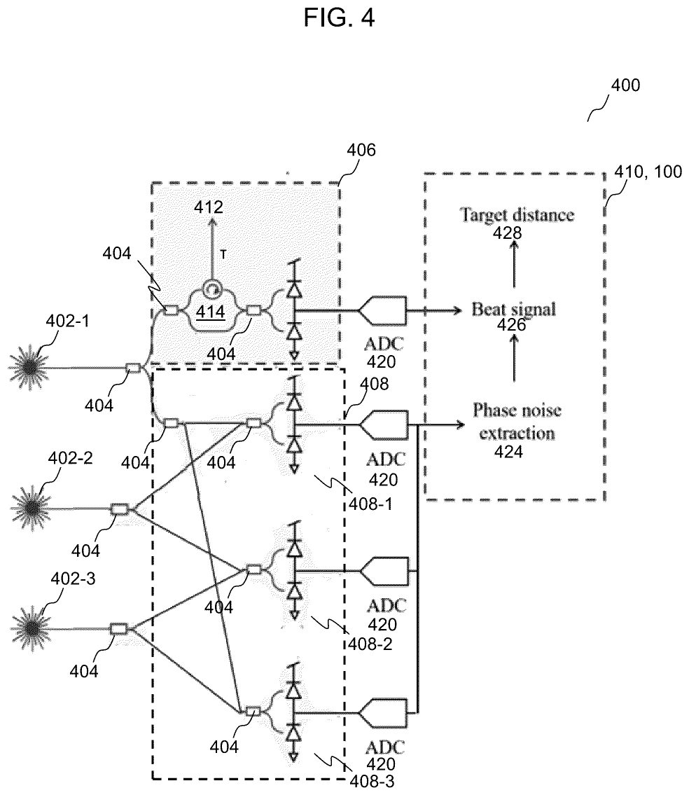

The third controller 120 may be an evaluation logic, e.g. to perform Fast-Fourier Transformation (FFT) on the edge corrected signal 118. The third controller 120 generates a measured time difference spectrum signal 122. The measured time difference spectrum signal 122 or a corresponding information can be provided to a controller controlling the LO-signal sources, e.g. controlling any of the transmission and generation of the respective LO-signal. The measured time difference spectrum signal 122 may be used as LO-signal for a measurement, e.g. in coherent LIDAR or RADAR applications, to determine a signal information, e.g. as illustrated in FIG. 4 for example. Note that the measured time difference spectrum signal 122 may be a measured spectrum. However, in addition, the measured time difference spectrum signal 122 may include processed signal, e.g. including a comparison of the measured spectrum with a threshold value or spectrum. Thus, the measured time difference spectrum signal 122 and may be a control signal for one of or multiple LO signal sources. Thus, the measured time difference spectrum signal 122 may include a signal associated to the measured time difference spectrum (also denoted as signal associated to the first signal). In other words, the signal associated to the measured time difference spectrum corresponds to a signal resulting to the comparison of the measured time difference spectrum with a reference signal (e.g. threshold value or threshold spectrum), e,g, the measured time differences, or their spectrum, or a signal derived thereof, e.g. a control signal for the LO signal sources.

Any of the first controller 112, the second controller 116 and the third controller 120 can be implemented in a single common circuit, or two or more separated circuits, e.g. integrated circuits.

As an example, the system 100 may be a means for operating a signal source. The means for operating a signal source may be any of an application specific integrated circuit (ASIC) and a plurality of integrated circuits (ICs). The means for operating a signal source may include a means for determining a time difference between a first reference point of a first signal 110 and a second reference point of a second signal 108. The first signal 110 may be modulated with a first frequency, and the second signal 108 may be modulated with a second frequency different from the first frequency. The means for determining a time difference may be the first controller 112 for example.

The means for operating a signal source may include a means for determining a phase noise based on the determined time difference. The means for determining a phase noise may be the second controller 116 for example.

The means for operating a signal source may have a means for controlling an operation of the signal source. The means for controlling an operation may monitor the phase noise, e.g. over the lifetime of a specific application, using the determined phase noise by processing a signal associated with the first signal. The signal associated with the first signal may be any of a measurement signal derived from the first signal, the first signal and a control signal to control the LO signal source emitting the first signal. As an example, the monitored phase noise may not just be one single phase noise value, e.g. for example at a specific frequency, but can be the whole phase noise spectrum for multiple frequencies. Alternatively, or in addition, the means for controlling an operation may change the LO signal source used to provide the first signal using the determined phase noise by processing a signal associated with the first signal. As an example, in case of a plurality of LO signal sources, the means for controlling an operation may switch the used LO signal source from a first LO signal source of high power consumption and lower phase noise to a second LO signal source of low power consumption and higher phase noise, or vice versa. Alternatively, or in addition, the means for controlling an operation may change the mode of operation of the LO signal sources using the determined phase noise by processing a signal associated with the first signal. As an example, various methods may be used to lower the phase noise of the LO signal sources, using a trade-off between higher power consumption and lower phase noise.

The means for controlling an operation may be the third controller 120 for example. Note that the first signal may be the first LO-signal 110 or the second LO-signal 108 as described above.

At least one of the first reference point and the second reference point may include a signal edge. For example, the first reference point may be a first signal edge and the second reference point may be a second signal edge. A signal edge may be a rising signal edge, as exemplary illustrated in FIG. 2A. The first signal and the second signal have about the same signal shape, e.g. the same wave shape or modulation (see also FIG. 2A).

The first frequency and the second frequency may be the same. Alternatively, the first frequency may be a multiple of the second frequency. For example, the first frequency may be in a range of about 1.1 to 10 times the second frequency. In other words, there may be two or more second reference points between two adjacent first reference points. Thus, the first signal may also be denoted as LO_{FAST} and the second signal may also be denoted as LO_{SLOW}.

The first signal and the second signal may be local oscillator signals. In other words, the first signal and the second signal may have a continuous signal modulation. The first signal and the second signal may be free of information modulation, e.g. free of a bit sequence corresponding to an information to be transmitted.

The means for determining the time difference may include a time-to-digital-converter, TDC, wherein the second signal may be a clock signal for the TDC and the first signal may be input for the TDC.

The means for determining the phase noise may determine the phase noise over a plurality of time differences, as illustrated in FIG. 2A. The means for determining the phase noise may determine the phase noise over a plurality of periods of at least one of the first signal and the second signal, as illustrated in FIG. 2A. For example, the means for determining the phase noise may determine the phase noise over a plurality of time differences over a plurality of periods of at least one of the first signal and the second signal, as illustrated in FIG. 2A.

The means for determining the phase noise transmits an information indicating the determined phase noise to the means for controlling an operation, wherein the means for controlling an operation controls any of the generation and the transmission the first signal. The information can be a feedback parameter used to control the signal source of the first signal, for example.

The means for determining the time difference may further determine another time difference between a third reference point of a third signal and at least one of the first reference point and the second reference point. The third signal may be modulated with a third frequency different from the first frequency and the second frequency, for example. A third signal source may generate the third signal. Alternatively, the first signal source generating the first signal or the second signal source generating the second signal may generate the third signal, e.g. using one or more of a multiplexer 106, or beam splitter and band pass filters.

Hence, the means for determining the phase noise may determine the phase noise based on the determined time differences, e.g. between one or more of the first signal, the second signal and the third signal. The means for controlling an operation may use the determined phase noise for processing a signal associated with the first signal, e.g. between one or more of the first signal, the second signal and the third signal. For example, the means for determining the phase noise may determine the phase noise based on time differences between any of the third reference point and the first reference point, the third reference point and the second reference point, and the first reference point and the second reference point. The means for determining the time difference may determine the time differences in parallel, e.g. at the same time. Alternatively, the means for determining the time difference may determine the time differences subsequently, e.g. one after another.

The means for controlling an operation may only correct the first signal, e.g. in LIDAR or RADAR applications with the first signal emitted to the environment of the system for distance measurements. Alternatively, the means for controlling an operation may also correct other signals than the first signal, e.g. the second signal, the third signal, etc, e.g. by using an alternative LO signal source or an alternative operation mode of the used LO signal sources.

The phase noise may be determined based on non-directly subsequent time differences. In other words, in case any of the first frequency and the second frequency are too large for signal processing, the used first subsequent reference points of subsequent signal periods.

Referring to FIG. 2A to FIG. 2D, random fluctuations in the phase of the first signal and second signal, e.g. expressed in the frequency domain as phase noise [symbol] may have an equivalent form in the time domain, e.g. a jitter τ(t). The phase noise of two LO-signals 108, 110 of different frequency, e.g. the first LO-signal 110 and the second LO-signal 108, or first signal and second signal, or LO_{SLOW} and LO_{FAST}, can be determined by determining how the time difference between signal edges (i.e. signal reference points) evolves with time.

FIG. 2A illustrates the timing diagram 200 of voltage 204 as a function of time 202 of an exemplary first LO-signal 110 and an exemplary second LO-signal 108. FIG. 2A further illustrates the evolving time difference τ_{td}(tⱼ) over various periods of the first LO-signal 108 and the second LO-signal 110. FIG. 2B illustrates the determined time difference 212 as a function of the number of signal reference points 214, and thus illustrates the evolving time difference τ_{td}(tⱼ) 216. Thus, FIG. 2B illustrates a deterministic jitter shift of the first and second LO-signals 108, 110. FIG. 2C illustrates the determined time difference 222 as a function of the number of signal reference points 224, and illustrates recovered random fluctuations 226. FIG. 2D illustrates the spectrum 232 of jitter determined using the time difference 236 vs. an expected jitter 238 as a function of frequency 234.

Illustratively, the first LO-signal 110 may be LO_{SLOW} used as Clock to trigger the TDC 112 (see FIG. 1). The oscillation period of the second LO-Signal 108, LO_{FAST} is shorter than of the first LO-Signal 110 LO_{SLOW} (see FIG. 2A). Thus, at least one rising signal edge of second LO-signal 110, LO_{FAST} occurs within a signal period of the first LO-signal 110, LO_{SLOW}. In other words, for each rising signal edge of LO_{SLOW} the TDC 112 determines the time difference τ_{td}(t) to the rising signal edge of the second LO-signal 108 LO_{FAST} of the previous signal time period. A purely random fluctuation function τ(t) (e.g. jitter) of the second LO-signal 108 (the first signal to be corrected as described above since the first LO-signal acts as clock signal) may be determined from the time series of these values τ_{td}(t), e.g. by removing a deterministic effect (see FIG. 2B with deterministic effect vs. FIG. 2C without deterministic effect).

For example, the position of the rising signal edge of the second LO-Signal 108, LO_{FAST} periodically shifts within the oscillation period of the first LO-signal 110, LO_{SLOW} (see FIG. 2A and FIG. 2B) due to different oscillation periods. This shift can be corrected by the second controller 116 described above. The second controller 116 determines the jitter function τ(t) and may subtract the deterministic edge shift from input signals 114-1, 114-2, 114-3, . . . , 114-M. The single input signals 114-1, 114-2, 114-3, . . . , 114-M between TDC 112 and second controller 116 may be a digital information representing which bin of the TDC 112 was activated. After two LO-sources of the plurality of LO-sources have been selected, the TDC 112 compares the time difference of their respective edges. Every time the time difference between the edges is measured, e.g. one per oscillation period, the TDC 112 may communicate this time difference to the second controller 116, e.g. the edge correction, via the single signals 114-1 . . . 114-M. For example, if the first single input signal 114-1 is high (and therefore all other single input signals are low) this means the last measured time difference was in the range of about 0 to about 5 ps. If for example the second single input signal 114-2 is high, this means that the last measured time difference was in the range of about 5 ps to about 10 ps. The further single input signals correspond to corresponding higher measured time differences. The single input signals may communicate the last measured time difference range from the TDC 112 to the second controller 116. In other words, the input signals 114-1, 114-2, 114-3, . . . , 114-M may not be associated to single oscillators 112.

The jitter function τ(t) may be solely governed by random fluctuations of signal phase, e.g. phase noise (PN). The third controller 120 may apply a Fast Fourier Transformation (FFT) to the jitter function τ(t). The FFT may yield in a spectrum S_{τ} 232, illustrated in FIG. 2D. The spectrum S_{τ} 232 can be directly related to the phase noise spectra [symbol] (f) of the first LO-signal f₁ and the phase noise spectra [symbol] (f) of the second LO-signal f₂:

$${S}_{τ} = \frac{1}{2 {π}^{2} {f}_{1}^{2}} {ℒ}_{1} ( f ) + \frac{1}{2 {π}^{2} {f}_{2}^{2}} {ℒ}_{2} ( f ) \qquad ( 1 )$$

Thus, FIG. 2D shows the comparison of the spectrum of the jitter function τ(t) 238 and compares it to the spectrum expected 236 for oscillators with the respective frequency and phase noise.

In case the determined phase noise exceeds a preset threshold value, the third control may provide a correction information to the controller of the signal source(s) of the first and second LO-signals. The correction signal may be indicative to a control parameter of the respective signal source(s), e.g. a voltage, a current, a temperature, an emission timing, etc.

Two or more LO-signals can be compared against each other in a ring-wise manner, for example. This may allow a calculation of phase noise for each single LO-signal.

In high frequency LO-signals the speed of digital measurement in the first controller 112 and the speed of the evaluation logic in the third controller 120 can be a limiting factor. Thus, the jitter determination in the second controller may use signals only every n-th signal edge to improve high frequency LO-signals (also denoted as determining phase noise based on non-directly subsequent time differences).

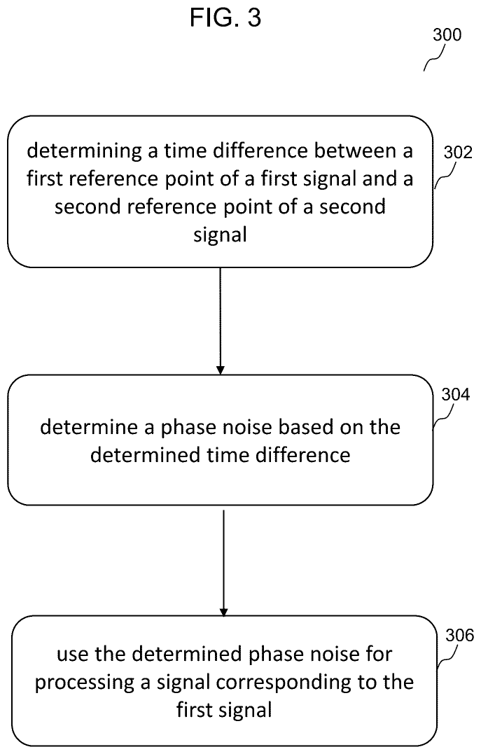

FIG. 3 illustrates a flow diagram for a method for correcting a signal. The method 300 may include determining 302 a time difference between a first reference point of a first signal and a second reference point of a second signal, the first signal modulated with a first frequency, and the second signal modulated with a second frequency different from the first frequency; determine 304 a phase noise based on the determined time difference; and use 306 the determined phase noise for processing a signal associated with the first signal.

The phase noise may be determined over a plurality of time differences. The phase noise may be determined over a plurality of periods of at least one of the first signal and the second signal. For example, the phase noise may be determined over a plurality of time differences over a plurality of periods of at least one of the first signal and the second signal.

The phase noise may be determined based on non-directly subsequent time differences.

The first signal may be corrected by providing an information indicating the determined phase noise to a controller controlling any of the generation and the transmission of the first signal.

At least one of the first reference point and the second reference point may include a signal edge. The first reference point may be a first signal edge and the second reference point may be a second signal edge.

The first frequency may be a multiple of the second frequency. The first frequency may be in a range of about 1.1 to 10 times the second frequency. The first signal and the second signal have about the same signal shape.

The method may further include determining another time difference between a third reference point of a third signal and at least one of the first reference point and the second reference point, the third signal modulated with a third frequency different from the first frequency and the second frequency. Determining the phase noise may be based on the determined time differences; and correcting the first signal may be using the determined phase noises. The phase noise may be determined based on time differences between any of the third reference point and the first reference point, the third reference point and the second reference point and the first reference point and the second reference point. The time differences may be determined in parallel. Alternatively, the time differences may be determined subsequently, e.g. by temporary storing measured phase noise functions.

The second signal may be used as clock signal for a time-to-digital-converter, TDC, wherein the first signal may be provided to an input of the TDC.

FIG. 4 illustrates a LIDAR device 400 for applying the signal correction method. The LIDAR system 400 may emit coherent light of the first laser source 402-1 to the object 412, e.g. a target in the environment of the LIDAR system 400.

In LIDAR applications, phase noise of a measurement light beam may lead to a change in the beat frequency 426 in the measurement signal 428. The signal correction method may increase the accuracy of a LIDAR system 400 by determining the phase noise of a laser source 402-1, and provide a corrected LO-signal in the processing of the first signal returned from an object 412, e.g. for coherent LIDAR, e.g. to determine a distance or movement of the object 412 in an improved manner, e.g. regarding energy consumption, processing time, signal-to-noise ratio, etc. For example, the phase noise of the coherent light (also denoted as laser beam) may be measured, and the measurement signal may be corrected using the measured time difference spectrum signal.

The LIDAR system 400 may include at least a first laser source 402-1, a second laser source 402-2, and a third laser source 402-3. Note that the laser sources 402-1, 402-2, 402-3 may be implemented by one (e.g. different modes or wavelengths of a single laser diode) or more laser diodes, for example.

In a LIDAR application, the statistical properties, e.g. the spectrum of the phase noise, and concrete values of the phase noise ϕ as a function of time (t) may be of interest. Therefore, for example, the LO-signals of at least a first laser source 402-1, a second laser source 402-2, and a third laser source 402-3 may be compared subsequently or in parallel, e.g. the time difference between the first LO-signal and the second LO-signal, the time difference between any of the first LO-signal and the third LO-signal, and the time difference between the second LO-signal and the third LO-signal. Thus, the method may determine the phase function ϕ₁(t) of the first laser source 402-1, the phase function ϕ₂(t) of the second laser source 402-2, and the phase function ϕ₃(t) of the third laser source 402-3, as described in more detail below.

The LIDAR system 400 may include a plurality of beam splitters 404 configured to splitting an input beam in an input ratio, e.g. 10% and 90%, or 50% and 50%, for example. The LIDAR system 400 may include a plurality of analog to digital changers (ADCs) 420. The LIDAR system 400 may include a plurality of optical amplifiers (not illustrated). The LIDAR system 400 may include a plurality of photodetectors (in FIG. 4 illustrated as diodes).

The LIDAR system 400 may include a LIDAR interferometer circuit 406, e.g. having a Mach-Zehnder interferometer (MZI) 406.

The LIDAR system 400 may include a processing circuit 410, e.g. a system 100 for signal correction as described above.

The LIDAR system 400 may include a monitoring circuit 408 having a plurality of monitoring sub-circuits 408-1, 408-2, 408-3.

A first monitoring sub-circuit 408-1 may compare the light of the first laser source 402-1 with the light of the second laser source 402-2, as described above. The first monitoring sub-circuit 408-1 provides a signal ϕ₁(t)+ϕ₂(t). The second monitoring sub-circuit 408-2 and the third monitoring sub-circuit 408-3 may provide a ring-wise comparison of the lights of the laser sources 402-1, 402-2, 402-3 to determine the phase noise ϕ₁(t) of the laser light of the first laser source 402-2 emitted to the object 412. Thus, determined phase noise functions ϕ₁(t)+ϕ₂(t), ϕ₂(t)+ϕ₃(t) and ϕ₁(t)+ϕ₃(t) for the same timeframe t allow to determine ϕ₁(t). Thus, using the determined phase noise of the first laser source 402-1, it is possible to mathematically correct the information from the noisy beat signal 426, and to improve the measured signal from the object 412. This system may allow correcting phase noise stemming from the optical components of the LIDAR system.

Alternatively, or in addition, an electronic modulation circuitry of the LIDAR system generating a sawtooth modulation of the laser beam output to the object 412 may be provided three times, also denoted as electronic modulation sub-circuitries (not shown). The electronic modulation sub-circuitries may provide the ringwise comparison signals of ϕ₁(t)+ϕ₂(t), ϕ₂(t)+ϕ₃(t) and ϕ₁(t)+ϕ₃(t) as described before that measure the phase noise stemming from the circuitry. The determined phase noise function may then be used to improve the measurement as described before. This system may allow correcting phase noise stemming from the electrical components of the LIDAR system used for the sawtooth modulation of the laser frequency.

Two or more of the determined fluctuation functions τ(t) allow to calculate a random portion of the lasers phase noise that the LIDAR system emits to the object 412 in the scene of the LIDAR system, and a corresponding correction can be made. Thus, a LIDAR system applying the method described above may overcome described quantization limitations. For example, a LIDAR system may use a plurality of laser sources wherein the LIDAR system emits only one laser beam to the object 412 in the environment of the LIDAR system at a time. The other non-emitting laser sources are in a pre-heated mode or stand-by mode. Thus, the laser source emitting laser light to the environment of the LIDAR system may provide the first signal (second LO-signal) as described above. Another, second laser source of the plurality of laser sources, e.g. any of a dedicated reference laser source, the laser source emitting laser light to the environment directly before the first laser source, and the laser source emitting laser light to the environment directly after the first laser source, may be used to provide the second signal (first LO-signal used as Clock in the TDC) as described above. The second laser source may not emit light to the environment of the LIDAR system. Instead, the laser light of the second laser source may be used solely internally in the LIDAR system. Thus, the measurement system considers safety requirements, e.g. eye-safety requirements. The first signal and second signal may be provided to the system 100 for signal correction by a beam splitter 404, to extract the phase noise.

Thus, the information provided by the system, e.g. before the FFT, the phase as a function of time ϕ(t)) can be used to increase the accuracy of the measurement. A correction algorithm may correct the measured data mathematically provided the phase information.

In other words and in a more general consideration, a measurement device may include a first signal source may be configured to transmit a first signal modulated with a first frequency, a second signal source may be configured to transmit a second signal modulated with a second frequency different from the first frequency, a first circuit may be configured to determine a time difference between a first reference point of the first signal and a second reference point of the second signal; a second circuit may be configured to determine a phase noise based on the determined time difference; and a third circuit may be configured to use the determined phase noise for processing a signal associated with the first signal.

The measurement device may be a RADAR device. Alternatively, the measurement device may be a LIDAR device.

The first circuit may be or may include the functions of the first controller described above. The second circuit may be or may include the functions of the second controller described above. The third circuit may be or may include the functions of the third controller described above.

The first signal may be a local oscillator for a measurement beam to determine at least a distance to an object in the environment of the measurement device. The second circuit may be configured to determine the phase noise over a plurality of time differences.

The first circuit may be configured to determine another time difference between a third reference point of a third signal transmitted from a third signal source and at least one of the first reference point and the second reference point, the third signal modulated with a third frequency different from the first frequency and the second frequency.

The second circuit may be configured to determine the phase noise over a plurality of periods of at least one of the first signal and the second signal. The second circuit may be configured to determine the phase noise over a plurality of time differences over a plurality of periods of at least one of the first signal and the second signal. The second circuit may be configured to determine the phase noise based on non-directly subsequent time differences. The second circuit may be configured to transmit an information indicating the determined phase noise to the third circuit, wherein the third circuit may be configured to control the transmission the first signal.

The second circuit may be configured to determine the phase noise based on the determined time differences; and the third circuit may be configured to use the determined phase noise for processing a signal associated with the first signals.

The second circuit may be configured to determine the phase noise based on time differences between any of the third reference point and the first reference point, the third reference point and the second reference point, and the first reference point and the second reference point. The second circuit may be configured to determine the time differences in parallel. Alternatively, the second circuit may be configured to determine the time differences subsequently. The second circuit may include a time-to-digital-converter, TDC, wherein the second signal may be a clock signal for the TDC and the first signal may be input for the TDC.

At least one of the first reference point and the second reference point may include a signal edge.

The first reference point may be a first signal edge and the second reference point may be a second signal edge.

The first frequency may be a multiple of the second frequency. The first frequency may be in a range of about 1.1 to 10 times the second frequency.

The first signal and the second signal have about the same signal shape. The first signal and the second signal may be local oscillator signals.

In another example, a communication device may include a first signal source configured to transmit a first signal modulated with a first frequency, a second signal source configured to transmit a second signal modulated with a second frequency different from the first frequency, a first circuit configured to determine a time difference between a first reference point of the first signal and a second reference point of the second signal; a second circuit configured to determine a phase noise based on the determined time difference; and a third circuit configured to use the determined phase noise for processing a signal associated with the first signal. The communication device may be a mobile terminal communication device. For example, the first signal may be a local oscillator for a communication signal with another communication device.

### EXAMPLES

The examples set forth herein are illustrative and not exhaustive.

Example 1 is a non-transitory computer readable medium having instructions stored therein that when executed by a processor cause the processor to: determine a time difference between a first reference point of a first signal and a second reference point of a second signal, the first signal modulated with a first frequency, and the second signal modulated with a second frequency different from the first frequency; determine a phase noise based on the determined time difference; and use the determined phase noise for processing a signal associated with the first signal.

In Example 2, the subject matter of Example 1 can optionally include that the instructions are configured to cause the processor to determine the phase over a plurality of time differences.

In Example 3, the subject matter of Example 1 or 2 can optionally include that the instructions are configured to cause the processor to determine the phase noise over a plurality of periods of at least one of the first signal and the second signal.

In Example 4, the subject matter of any one of Examples 1 to 3 can optionally include that the instructions are configured to cause the processor to determine the phase noise over a plurality of time differences over a plurality of periods of at least one of the first signal and the second signal.

In Example 5, the subject matter of any one of Examples 1 to 4 can optionally include that the instructions are configured to cause the processor to use the determined phase noise for processing a signal associated with the first signal by performing a fast Fourier transformation.

In Example 6, the subject matter of any one of Examples 1 to 5 can optionally include that the instructions are configured to cause the processor to improve the first signal and the second signal using the determined phase noise.

In Example 7, the subject matter of any one of Examples 1 to 6 can optionally include that the instructions are configured to cause the processor to determine the phase noise based on non-directly subsequent time differences.

In Example 8, the subject matter of any one of Examples 1 to 7 can optionally include that the instructions are configured to cause the processor to improve the first signal by providing an information indicating the determined phase noise to a controller controlling any of the generation and the transmission of the first signal.

In Example 9, the subject matter of any one of Examples 1 to 8 can optionally include that at least one of the first reference point and the second reference point includes a signal edge, e.g. a rising signal edge.

In Example 10, the subject matter of any one of Examples 1 to 9 can optionally include that the first reference point is a first signal edge and the second reference point is a second signal edge.

In Example 11, the subject matter of any one of Examples 1 to 10 can optionally include that the first frequency is a multiple of the second frequency.

In Example 12, the subject matter of any one of Examples 1 to 11 can optionally include that the first frequency is in a range of about 1.1 to 10 times the second frequency.

In Example 13, the subject matter of any one of Examples 1 to 12 can optionally include that the first signal and the second signal have about the same signal shape or amplitude modulation.

In Example 14, the subject matter of any one of Examples 1 to 13 can optionally include that the instructions are further configured to cause the processor to determine another time difference between a third reference point of a third signal and at least one of the first reference point and the second reference point, the third signal modulated with a third frequency different from the first frequency and the second frequency.

In Example 15, the subject matter of Example 14 can optionally include that the instructions are configured to cause the processor to determine the phase noise based on the determined time differences; and to use the determined phase noise for processing a signal associated with the first signals.

In Example 16, the subject matter of any one of Examples 14 to 15 can optionally include that the instructions are configured to cause the processor to determine the phase noise based on time differences between any of the third reference point and the first reference point, the third reference point and the second reference point, and the first reference point and the second reference point

In Example 17, the subject matter of any one of Examples 14 to 16 can optionally include that the instructions are configured to cause the processor to determine the time differences in parallel.

In Example 18, the subject matter of any one of Examples 14 to 16 can optionally include that the instructions are configured to cause the processor to determine the time differences subsequently.

In Example 19, the subject matter of any one of Examples 1 to 18 can optionally include that the first signal and the second signal are local oscillator signals.

In Example 20, the subject matter of any one of Examples 1 to 19 can optionally include that the instructions are configured to cause the processor to use the second signal as clock signal for a time-to-digital-converter, TDC, and to use the first signal as an input of the TDC.

Example 21 is a means for operating a signal source, including: a means for determining a time difference between a first reference point of a first signal and a second reference point of a second signal, the first signal modulated with a first frequency, and the second signal modulated with a second frequency different from the first frequency; a means for determining a phase noise based on the determined time difference; and a means to use the determined phase noise for processing a signal associated with the first signal.

In Example 22, the subject matter of Example 21 can optionally include that the means for determining a phase noise determines the phase noise over a plurality of time differences.

In Example 23, the subject matter of any one of Examples 21 to 22 can optionally include that the means for determining a phase noise determines the phase noise over a plurality of periods of at least one of the first signal and the second signal.

In Example 24, the subject matter of any one of Examples 21 to 23 can optionally include that the means for determining a phase noise determines the phase noise over a plurality of time differences over a plurality of periods of at least one of the first signal and the second signal.

In Example 25, the subject matter of any one of Examples 21 to 24 can optionally include that the means for controlling an operation uses a fast Fourier transformation to improve the first signal.

In Example 26, the subject matter of any one of Examples 21 to 25 can optionally include that the first signal and the second signal are corrected using the determined phase noise.

In Example 27, the subject matter of any one of Examples 21 to 26 can optionally include that the means for determining the phase noise determines the phase noise based on non-directly subsequent time differences.

In Example 28, the subject matter of any one of Examples 21 to 27 can optionally include that the means for determining the phase noise transmits an information indicating the determined phase noise to the means for controlling an operation, wherein the means for controlling an operation controls any of the generation and the transmission the first signal.

In Example 29, the subject matter of any one of Examples 21 to 28 can optionally include that at least one of the first reference point and the second reference point includes a signal edge.

In Example 30, the subject matter of any one of Examples 21 to 29 can optionally include that the first reference point is a first signal edge and the second reference point is a second signal edge.

In Example 31, the subject matter of any one of Examples 21 to 30 can optionally include that the first frequency is a multiple of the second frequency.

In Example 32, the subject matter of any one of Examples 21 to 31 can optionally include that the first frequency is in a range of about 1.1 to 10 times the second frequency.

In Example 33, the subject matter of any one of Examples 21 to 32 can optionally include that the first signal and the second signal have about the same signal shape.

In Example 34, the subject matter of any one of Examples 21 to 33 can optionally include that the means for determining the time difference further determines another time difference between a third reference point of a third signal and at least one of the first reference point and the second reference point, the third signal modulated with a third frequency different from the first frequency and the second frequency.

In Example 35, the subject matter of Example 34 can optionally include that the means for determining the phase noise determines the phase noise based on the determined time differences; and the means for controlling an operation controls the first signal using the determined phase noises.

In Example 36, the subject matter of any one of Examples 34 to 35 can optionally include that the means for determining a phase noise determines the phase noise based on time differences between any of the third reference point and the first reference point, the third reference point and the second reference point, and the first reference point and the second reference point

In Example 37, the subject matter of any one of Examples 34 to 36 can optionally include that the means for determining the time difference determines the time differences in parallel.

In Example 38, the subject matter of any one of Examples 34 to 36 can optionally include that the means for determining the time difference determines the time differences subsequently.

In Example 39, the subject matter of any one of Examples 21 to 38 can optionally include that the first signal and the second signal are local oscillator signals.

In Example 40, the subject matter of any one of Examples 21 to 39 can optionally include that the means for determining a time difference includes a time-to-digital-converter, TDC, wherein the second signal is a clock signal for the TDC and the first signal is input for the TDC.

Example 41 is a communication device, including a first signal source configured to transmit a first signal modulated with a first frequency, a second signal source configured to transmit a second signal modulated with a second frequency different from the first frequency, a first circuit configured to determine a time difference between a first reference point of the first signal and a second reference point of the second signal; a second circuit configured to determine a phase noise based on the determined time difference; and a third circuit configured to use the determined phase noise for processing a signal associated with the first signal.

In Example 42, the subject matter of Example 41 can optionally include that the communication device is a mobile terminal communication device.

In Example 43, the subject matter of any one of Examples 41 to 42 can optionally include that the first signal is a local oscillator for a communication signal with another communication device.

Example 44 is a measurement device, including a first signal source configured to transmit a first signal modulated with a first frequency, a second signal source configured to transmit a second signal modulated with a second frequency different from the first frequency, a first circuit configured to determine a time difference between a first reference point of the first signal and a second reference point of the second signal; a second circuit configured to determine a phase noise based on the determined time difference; and a third circuit configured to use the determined phase noise for processing a signal associated with the first signal.

In Example 45, the subject matter of Example 44 can optionally include that the measurement device is a RADAR device.

In Example 46, the subject matter of any one of Examples 44 to 45 can optionally include that the measurement device is a LIDAR device.

In Example 47, the subject matter of any one of Examples 44 to 46 can optionally include that the first signal is a local oscillator for a measurement beam to determine at least a distance to an object in the environment of the measurement device.

In Example 48, the subject matter of any one of Examples 41 to 47 can optionally include that the second circuit is configured to determine the phase noise over a plurality of time differences.

In Example 49, the subject matter of any one of Examples 41 to 48 can optionally include that the second circuit is configured to determine the phase noise over a plurality of periods of at least one of the first signal and the second signal.

In Example 50, the subject matter of any one of Examples 41 to 49 can optionally include that the second circuit is configured to determine the phase noise over a plurality of time differences over a plurality of periods of at least one of the first signal and the second signal.

In Example 51, the subject matter of any one of Examples 41 to 50 can optionally include that the third circuit is configured to improve the first signal using a fast Fourier transformation indicating an information to improve the first signal.

In Example 52, the subject matter of any one of Examples 41 to 51 can optionally include that the third circuit is configured to improve the first signal and the second signal using the determined phase noise.

In Example 53, the subject matter of any one of Examples 41 to 52 can optionally include that the second circuit is configured to determine the phase noise based on non-directly subsequent time differences.

In Example 54, the subject matter of any one of Examples 41 to 53 can optionally include that second circuit configured to transmits an information indicating the determined phase noise to the third circuit, wherein the third circuit is configured to control any of the generation and the transmission the first signal.

In Example 55, the subject matter of any one of Examples 41 to 54 can optionally include that at least one of the first reference point and the second reference point includes a signal edge.

In Example 56, the subject matter of any one of Examples 41 to 55 can optionally include that the first reference point is a first signal edge and the second reference point is a second signal edge.

In Example 57, the subject matter of any one of Examples 41 to 56 can optionally include that the first frequency is a multiple of the second frequency.

In Example 58, the subject matter of any one of Examples 41 to 57 can optionally include that the first frequency is in a range of about 1.1 to 10 times the second frequency.

In Example 59, the subject matter of any one of Examples 41 to 58 can optionally include that the first signal and the second signal have about the same signal shape.

In Example 60, the subject matter of any one of Examples 41 to 59 can optionally include that the first circuit is configured to determine another time difference between a third reference point of a third signal transmitted from a third signal source and at least one of the first reference point and the second reference point, the third signal modulated with a third frequency different from the first frequency and the second frequency.

In Example 61, the subject matter of Example 60 can optionally include that the second circuit is configured to determine the phase noise based on the determined time differences; and the third circuit is configured to use the determined phase noise for processing a signal associated with the first signals.

In Example 62, the subject matter of any one of Examples 60 to 61 can optionally include that the second circuit is configured to determine the phase noise based on time differences between any of the third reference point and the first reference point, the third reference point and the second reference point, and the first reference point and the second reference point

In Example 63, the subject matter of any one of Examples 60 to 62 can optionally include that the second circuit is configured to determine the time differences in parallel.

In Example 64, the subject matter of any one of Examples 60 to 63 can optionally include that the second circuit is configured to determine the time differences subsequently.

In Example 65, the subject matter of any one of Examples 41 to 64 can optionally include that the first signal and the second signal are local oscillator signals.

In Example 66, the subject matter of any one of Examples 41 to 65 can optionally include that the second circuit includes a time-to-digital-converter, TDC, wherein the second signal is a clock signal for the TDC and the first signal is input for the TDC.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A non-transitory computer readable medium having instructions stored therein that when executed by a processor cause the processor to:
determine a time difference between a first reference point of a first signal and a second reference point of a second signal, the first signal modulated with a first frequency, and the second signal modulated with a second frequency different from the first frequency;
determine a phase noise based on the determined time difference; and
use the determined phase noise for processing a signal associated with the first signal.

2. The non-transitory computer readable medium of claim 1, wherein the instructions are configured to cause the processor to determine the phase noise over a plurality of time differences over a plurality of periods of at least one of the first signal and the second signal.

3. The non-transitory computer readable medium of claim 1, wherein the instructions are configured to cause the processor to use the determined phase noise for processing a signal associated with the first signal by performing a fast Fourier transformation.

4. The non-transitory computer readable medium of claim 1, wherein the instructions are configured to cause the processor to determine the phase noise based on non-directly subsequent time differences.

5. The non-transitory computer readable medium of claim 1, wherein the instructions are configured to cause the processor to improve the first signal by providing an information indicating the determined phase noise to a controller controlling any of the generation and the transmission of the first signal.

6. The non-transitory computer readable medium of claim 1, wherein at least one of the first reference point and the second reference point comprises a signal edge.

7. The non-transitory computer readable medium of claim 1, wherein the first reference point is a first signal edge and the second reference point is a second signal edge.

8. The non-transitory computer readable medium of claim 1, wherein the instructions are further configured to cause the processor to determine another time difference between a third reference point of a third signal and at least one of the first reference point and the second reference point, the third signal modulated with a third frequency different from the first frequency and the second frequency.

9. The non-transitory computer readable medium of claim 1, wherein the instructions are configured to cause the processor to determine the phase noise based on time differences between any of the third reference point and the first reference point, the third reference point and the second reference point and the first reference point and the second reference point.

10. A communication device, comprising
a first signal source configured to transmit a first signal modulated with a first frequency,
a second signal source configured to transmit a second signal modulated with a second frequency different from the first frequency,
a first circuit configured to determine a time difference between a first reference point of the first signal and a second reference point of the second signal;
a second circuit configured to determine a phase noise based on the determined time difference; and
a third circuit configured to use the determined phase noise for processing a signal associated with the first signal.

11. The communication device of claim 10, wherein the communication device is a mobile communication device.

12. The communication device of claim 10, wherein the first signal is a local oscillator for a communication signal with another communication device.

13. The means for operating a signal source of claim 10, wherein the second circuit determines the phase noise over a plurality of time differences over a plurality of periods of at least one of the first signal and the second signal.

14. The means for operating a signal source of claim 10, wherein the second circuit determines phase noise based on non-directly subsequent time differences.

15. The means for operating a signal source of claim 10, wherein the second circuit transmits an information indicating the determined phase noise to the third circuit, wherein the third circuit controls any of the generation and the transmission the first signal.

16. The means for operating a signal source of claim 10, wherein the first circuit comprises a time-to-digital-converter, TDC, wherein the second signal is a clock signal for the TDC and the first signal is input for the TDC.

17. A measurement device, comprising
a first signal source configured to transmit a first signal modulated with a first frequency,
a second signal source configured to transmit a second signal modulated with a second frequency different from the first frequency,
a first circuit configured to determine a time difference between a first reference point of the first signal and a second reference point of the second signal;
a second circuit configured to determine a phase noise based on the determined time difference; and
a third circuit configured to use the determined phase noise for processing a signal associated with the first signal.

18. The measurement device of claim 17, wherein the measurement device is a RADAR device or a LIDAR device.

19. The measurement device of claim 17, wherein the first circuit comprises a time-to-digital-converter, TDC, wherein the second signal is a clock signal for the TDC and the first signal is input for the TDC.

20. The measurement device of claim 17, wherein the first signal is a local oscillator for a measurement beam to determine at least a distance to an object in the environment of the measurement device.
